(19) United States
(12) Patent Application Publication
(10) Pub. No.: US 2026/0264188 A1
(43) Pub. Date: Sep. 10, 2026

(54) TOOL FOR CONDUITS

(71) Applicant: RELIANCE WORLDWIDE CORPORATION, Atlanta, GA (US)

(72) Inventor: Sai Kishore RAVISANKAR, Alpharetta, GA (US)

(21) Appl. No.: 19/165,521

(22) PCT Filed: Feb. 6, 2024
(86) PCT No.: PCT/US2024/014547

§ 371 Date: Sep. 15, 2025

Related U.S. Application Data
(60) Provisional application No. 63/491,767, filed on Mar. 23, 2023.

(51) Int. Cl. B24B 9/00; B25F 5/00

(52) U.S. Cl. CPC B24B 9/007; B25F 5/00

(57) ABSTRACT

A conduit preparation tool includes a hub. The preparation tool may further includes a plurality of conduit receivers coupled to the hub and spaced apart from one another around a central axis extending through the hub. Each of the plurality of conduit receivers may have a cylindrical shape with a different diameter from one another to receive a respective conduit therein. Each of the pluof conduit receivers may have a respective receiver axis extending through the central axis. The preparation tool may further include a plurality of deburr elements coupled to the hub and arranged extend partially into at least one of the conduit receivers to trim portions of the respective conduit received therein in response to rotation of the preparation tool about the respective receiver axis.

### PRIORITY CLAIM

This application claims benefit of co-pending U.S. provisional patent application No. 63/491,767, filed Mar. 23, 2023, entitled TOOL FOR CONDUITS, the disclosure of which is incorporated by reference in its entirety herein.

### TECHNICAL FIELD

The present disclosure relates generally to plumbing tools for preparation of conduits, including pipes, and particularly to deburr and depth tools for pipes.

### BACKGROUND

Various tools may be used to ready a fluid conduit for attachment to a connector. Deburr tools may be used to remove or trim material from the fluid conduit prior to attachment to the connector. Depth gauges may be used to mark a particular location on the fluid conduit that relates to its attachment with the connector. At times, the end of the fluid conduit can be located in a hard to access area where such tools are difficult to manipulate to achieve the desired result.

### SUMMARY

Embodiments of the present application relate to a conduit, e.g., a pipe, preparation tool. In embodiments, the preparation tool can include a pipe deburr and depth tool. The preparation tool includes a hub, a plurality of conduit receivers, and a plurality of deburr portions or other features configured or adapted to remove burrs or other debris, such as due to cutting, from ends of conduits. The plurality of conduit receivers are coupled to the hub and spaced apart from one another about the hub. Each of the plurality of conduit receivers may have a cylindrical shape with a different diameter from one another to receive a specific sized or dimensioned conduit therein. Each of the plurality of conduit receivers may have a respective receiver axis extending through the central axis. The plurality of deburr elements are coupled to the hub and arranged to extend partially into at least one of the conduit receivers to trim portions of the respective pipe received therein in response to rotation of the preparation tool about the respective receiver axis. The conduit preparation tool can also be used for depth measurement so that an installer can mark a pipe insertion depth on the fluid conduit that corresponds with a proper installation depth of the fluid conduit with a pipe connector.

In embodiments, each of the plurality of conduit receivers are sized, configured, and/or spaced or oriented about the central axis such that the preparation tool is free to rotate thereabout within a predetermined diameter of less than 3.5 inches. In this regard, with embodiments of the present disclosure, the preparation tool can be used to deburr installed conduits in place, reducing the need to significantly tear out or otherwise remove drywall or other structural elements, constructions panels, etc. and/or otherwise to uninstall, remove, or otherwise replace sections of installed conduit. For example, the preparation tool is sized, dimensioned, oriented, constructed, or otherwise configured such that the preparation tool can be freely rotated between adjacent drywall or other construction paneling connected on opposite sides of a stud, such as a 2 inch by 4 inch wooden stud, a 4 inch×4 inch wooden stud, etc.

In embodiments, the plurality of conduit receivers includes a first conduit receiver, a second conduit receiver, and a third conduit receiver. In some embodiments, one or more of the conduit receivers, such as the first conduit receiver and the second conduit receiver, include an open, distal end having recessed segments or portions. In some embodiments, at least one of the conduit receivers, such as the third conduit receiver, has a distal, open end that does not include recessed segments or portions, and in this regard, includes an end surface that falls within a single plane, i.e., is entirely circular and planar.

In embodiments, the first conduit receiver has a first diameter equal to about 1 inch for receipt of 1 inch diameter conduits, the second conduit receiver has a second diameter equal to about ¾ inch for receipt of ¾ inch diameter conduits, and the third conduit receiver has a third diameter equal to about ½ inch for receipt of ½ inch diameter conduits.

In embodiments, each of the recessed segments include arcuate or otherwise curved segments that have a specified radius of curvature. In this regard, the radius of curvature is selected such that the conduit receivers including the recessed segments are oriented within the predetermined diameter of less than 3.5 inches, e.g., such that the preparation tool is free to spin between adjacent drywall or other construction paneling sections.

In some embodiments, each of the conduit receivers further includes a proximal end coupled to the hub, and each of the planar segments is spaced apart from each corresponding proximal end by a predetermined distance to provide an insertion depth of the specific conduit received therein that corresponds with a proper installation depth of the specific pipe with a corresponding pipe connector. As a result, the preparation tool provides both deburring and depth measurement capabilities in tight and hard to access areas of a building.

### BRIEF DESCRIPTION OF THE FIGURES

By way of example only, other embodiments of the present disclosure will be described more fully hereinafter with reference to the accompanying figures, in which like numbers refer to like parts throughout, wherein:

FIG. 1 is a perspective view of a pipe preparation tool including a hub, a plurality of conduit receivers, and a plurality of deburr elements in accordance with principles of the present disclosure;

FIG. 2 is a side elevation view of the pipe preparation tool of FIG. 1 positioned between two drywall panels and within an actual width of a stud, according to an example embodiment;

FIG. 3 is an enlarged view of a portion of FIG. 2 showing a first conduit receiver included in the plurality of conduit receivers in accordance with the principles of the present disclosure;

FIG. 4 is a perspective view of the first conduit receiver, according to an example embodiment;

FIG. 5 is an enlarged view of a portion of FIG. 2 showing a second conduit receiver included in the plurality of conduit receivers in accordance with the principles of the present disclosure;

FIG. 6 is a perspective view of the second conduit receiver, according to an example embodiment;

FIG. 7 is an enlarged view of a portion of FIG. 2 showing a third conduit receiver included in the plurality of conduit receivers in accordance with the principles of the present disclosure;

FIG. 8 is a perspective view of the third conduit receiver, according to an example embodiment;

FIG. 9 is a perspective view of another embodiment of a pipe preparation tool, according to an example embodiment;

FIG. 10 is a front view of the pipe preparation tool of FIG. 9;

FIG. 11 is a rear view of the pipe preparation tool of FIG. 9;

FIG. 12 is an enlarged perspective view of a first conduit receiver included in the pipe preparation tool of FIG. 9;

FIG. 13 is an enlarged perspective view of a second conduit receiver included in the pipe preparation tool of FIG. 9; and

FIG. 14 is an enlarged perspective view of a third conduit receiver included in the pipe preparation tool of FIG. 9.

### DETAILED DESCRIPTION

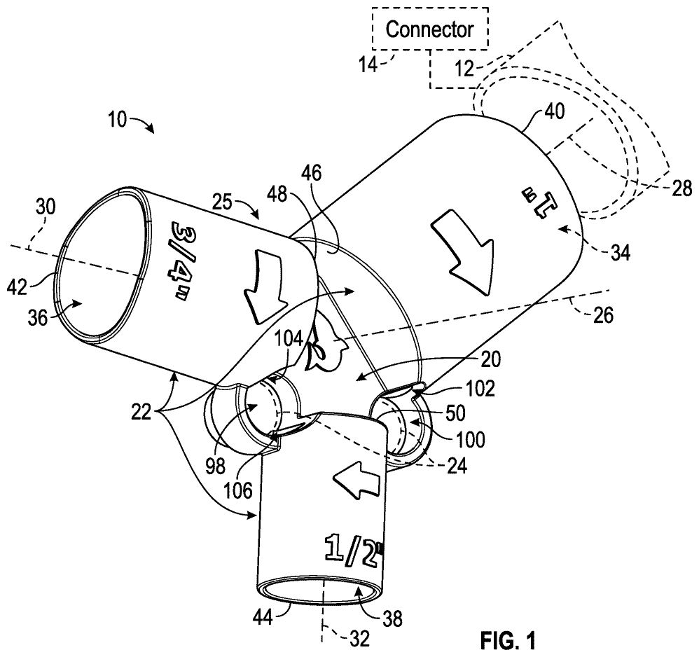

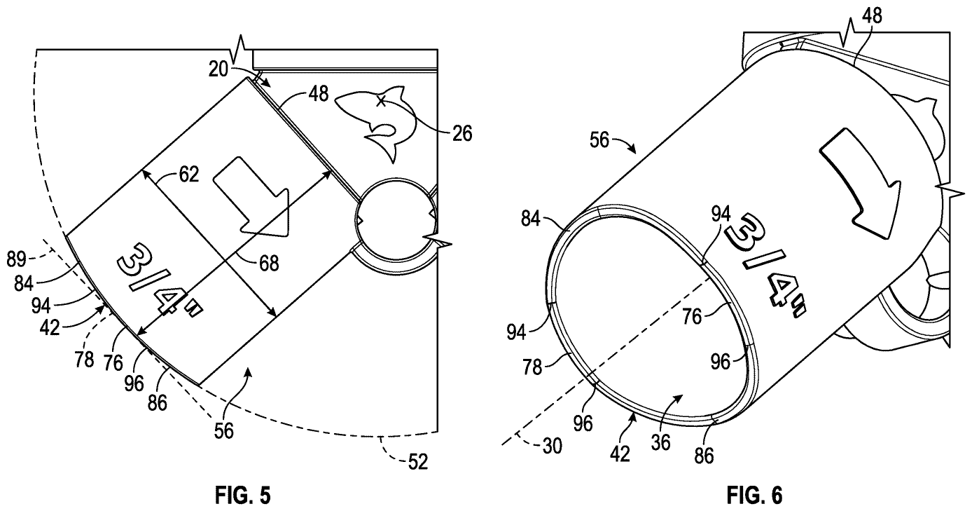

A conduit or pipe preparation tool 10, in accordance with the illustrative embodiment, is shown in FIGS. 1-8. The preparation tool 10 is configured to be used by an installer to prepare an end of a fluid conduit 12, such as a copper pipe, PEX tubing, CPVC pipe, PVC tubing, and the like, for attachment to a conduit connector 14, such as a push-to-connect, push-fit, or other plumbing connector or coupling. As an example, the preparation tool 10 is configured to deburr or otherwise remove debris from an end of the fluid conduit 12 for preparation of the fluid conduit 12 for insertion into the connector 14, e.g., to reduce the likelihood of damage to components of the plumbing coupling, such as the O-ring seal, and further to help ensure that the fluid conduit 12 subsequently forms a substantially watertight connection with the connector 14. The preparation tool 10 can also be used for depth measurement so that the installer can mark an insertion depth on the fluid conduit 12 that corresponds with a proper installation depth of the fluid conduit 12 with the connector 14.

As an example, the preparation tool 10 can be used to deburr and depth mark a fluid conduit for a SharkBite® Branded Push-to-Connect Plumbing System manufactured by Reliance Worldwide Corporation located at 2300 Defoor Hills Rd NW, Atlanta, GA 30318. An example of a push to connect connector or coupling is provided in U.S. Pat. No. 11,525,534, issued Dec. 13, 2022, which is incorporated by reference herein in its entirety.

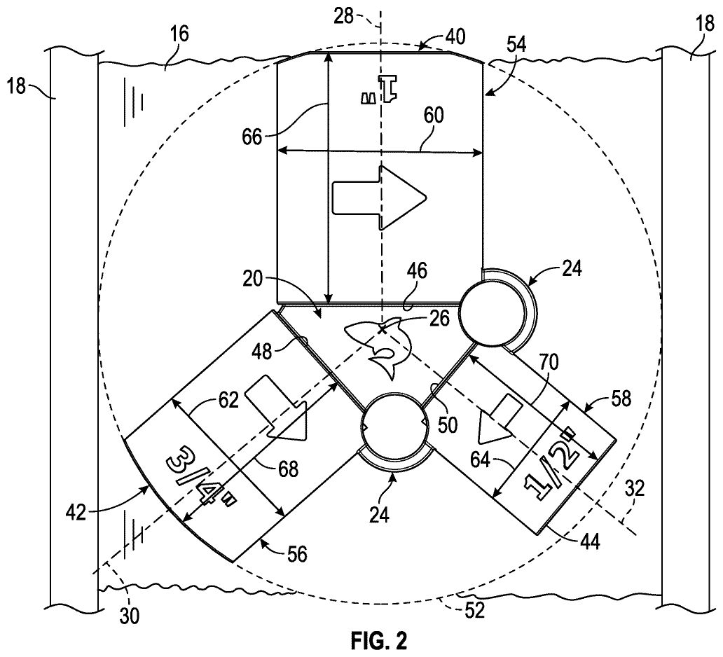

Referring to FIGS. 1 and 2, the preparation tool 10 includes a hub 20, a plurality of conduit receivers 22 coupled to the hub 20, and a plurality of conduit deburr portions or clements 24 coupled to the plurality of conduit receivers 22. The deburr elements 24 include deburring knives or other suitable cutting portions, such as circular cutting portions as shown throughout the figures of the present application. The plurality of conduit receivers 22 are formed with the hub 20 to form a single piece, unitary body 25. For example, the unitary body 25 including the plurality of conduit receivers 22 and hub 20 are formed as part of a single injection molding process. In one example, the unitary body 25 is formed from a polymeric material, such PP, PE, PA, or other polymeric materials. The unitary body 25 can be formed from other suitable materials, e.g., composite or synthetic materials, without departing from the scope of the present disclosure.

The plurality of conduit receivers 22 and deburr elements 24 are arranged radially around a central axis 26 that extends through the hub 20 as shown in FIGS. 1 and 2. Each of the plurality of conduit receivers 22 has a cylindrical shape that extends circumferentially about a respective axis 28, 30, 32 to provide an open interior 34, 36, 38 for each of the conduit receivers 22. Each deburr element 24 is coupled to a proximal end 46, 48, 50 of at least one of the conduit receivers 22 and partially extends into at least one of the open interiors 34, 36, 38 to engage and remove material from an end of the fluid conduit 12.

Each open interior 34, 36, 38 is sized to receive a corresponding fluid conduit 12 of a specific diameter therein along a corresponding receiver axis 28, 30, 32 to help to guide the corresponding fluid conduit 12 to one of the plurality of deburr elements 24. Once the fluid conduit 12 is fully inserted, e.g., inserted to a depth where the end of the conduit engages or contacts a corresponding deburr element, into the corresponding conduit receiver 22, the preparation tool 10 is configured to be rotated about the corresponding axis 28, 30, 32 so that at least one of the deburr elements 24 engages and removes burrs, debris, or other undesired material from the end of the fluid conduit 12. At the same time, the fluid conduit 12 can also be marked at the proper installation depth by placing a mark (not shown) on a side of the fluid conduit 12 that aligns with a distal end 40, 42, 44 of the corresponding conduit receiver 22. This marking helps to ensure the conduit 12 is sufficiently inserted, e.g., fully inserted, into a corresponding connector or coupling 14, e.g., such that when the end of the conduit engages an end stop, the conduit sufficiently engages a sealing o-ring of the coupling, etc. Each receiver axis 28, 30, 32 intersects the central axis 26 and is arranged perpendicular to the central axis 26. In this way, each of the conduit receivers 22 extends outwardly away from the central axis 26, the hub 20, and from one another.

The preparation tool 10 is sized, structured, and configured to fit in hard-to-access areas so that the installer can easily access the ends of fluid conduits 12 between studs 16 and/or wall panels 18 of a wall in a building, for example, as suggested in FIG. 2. In an exemplary building, walls of the building are constructed with studs 16 and drywall panels 18 coupled to each end of the studs 16. Typical studs 16 are referred to as having a 2 inch thickness and a 4 inch width (i.e. a 2 by 4), but can have an actual thickness of about 1.5 inches and an actual width of about 3.5 inches. In the illustrative embodiment, the distal end 40, 42, 44 of each of the plurality of conduit receivers 22 is spaced apart from the central axis 26 by a distance of less than or equal to 3.5 inches so that the preparation tool 10 is free to rotate about the central axis 26 at or within a predetermined diameter 52 of less than or equal to 3.5 inches as suggested in FIG. 2. The predetermined diameter 52 represents the actual width of a typical stud 16 and the spacing between two drywall panels 18, which is defined substantially by the actual width of the stud 16. In the illustrative embodiment, the preparation tool 10 also has an aspect ratio of about 1:1 in its widest and tallest dimensions. In this way, the preparation tool 10 is able to reside completely within the predetermined diameter 52. Because of these dimensional attributes of the preparation tool 10, an installer is able to reach between two drywall panels 18 with the central axis 26 of the preparation tool 10 arranged perpendicularly to the stud 16. With the preparation tool 10 between the two drywall panels 18, the installer is free to rotate the preparation tool 10 about the central axis 26 without interference with the drywall panels 18 to align any of the conduit receivers 22 with an end of the fluid conduit 12 also between the two drywall panels 18 at any orientation relative to the stud 16 and the walls 18. The preparation tool 10 can also be rotated about any of the receiver axes 28, 30, 32 within the predetermined diameter 52 to deburr the end of the fluid conduit 12 between two drywall panels 18.

It should be noted that the stud 16 can have dimensions that are different from a 2inch by 4 inch stud such as a 4 inch by 4 inch stud, a 2 inch by 6 inch stud, a 4 inch by 8 inch stud, etc. Thus, in some embodiments, the predetermined diameter may differ from 3.5 inches. In an example, the predetermined diameter 52 may be about 7.5 inches in the case of a 4 inch by 8 inch stud or about 5.5 inches in the case of a 2 inch by 6 inch stud. In other embodiments, the predetermined diameter 52 is less than 7.5 inches, less than 7.4 inches, less than 7.3 inches, less than 7.2 inches, less than 7.1 inches, less than 7 inches, less than 6.9 inches, less than 6.8 inches, less than 6.7 inches, less than 6.6 inches, less than 6.5 inches, less than 6.4 inches, less than 6.3 inches, less than 6.2 inches, less than 6.1 inches, less than 6 inches, less than 5.9 inches, less than 5.8 inches, less than 5.7 inches, less than 5.6 inches, less than 5.5 inches, less than 5.4 inches, less than 5.3 inches, less than 5.2 inches, less than 5.1 inches, less than 5 inches, less than 4.9 inches, less than 4.8 inches, less than 4.7 inches, less than 4.6 inches, less than 4.5 inches, less than 4.4 inches, less than 4.3 inches, less than 4.2 inches, less than 4.1 inches, less than 4.0 inches, less than 3.9 inches, less than 3.8 inches, less than 3.7 inches, less than 3.6 inches, less than 3.5 inches, less than 3.4 inches, less than 3.3 inches, less than 3.2 inches, less than 3.1 inches, less than 3 inches, etc.

In the illustrative embodiment, the plurality of conduit receivers 22 includes a first conduit receiver 54, a second conduit receiver 56, and a third conduit receiver 58 each located at different circumferential locations relative to one another about the central axis 26 as shown in FIG. 2. The conduit receivers 54, 56, 58 each have a different diameter from one another to receive different conduits that have a corresponding diameter. For example, the first conduit receiver 54 has a first diameter 60 that is sized to fit a 1 inch diameter conduit. The second conduit receiver 56 has a second diameter 62, smaller than the first diameter 60, which is sized to fit a ¾ inch diameter conduit. The third conduit receiver 58 has a third diameter 64, smaller than the first and second diameters 60, 62, which is sized to fit a ½ inch conduit. It should be noted that, the conduit receivers 22 may have any suitable diameter to fit conduits of any size so long as the preparation tool 10 is still able to fit and rotate within the predetermined diameter 52. For example, any of the conduit receivers 22 may have a diameter for receipt of larger or smaller diameter conduits, e.g., a 6 inch diameter conduit, a 5 inch diameter conduit, a 4 inch diameter conduit, a 3 inch diameter conduit, a 2½ inch diameter conduit, a 2 inch diameter conduit, a 1½ inch diameter conduit, a 1¼ inch diameter conduit, a ⅜ inch diameter conduit, a ¼ inch diameter conduit, a ⅛ inch diameter conduit, etc.

Referring to FIGS. 2-8, the conduit receivers 22 are also sized with a different height from one another so that the installation depth mark location provided by cach conduit receiver 22 corresponds with the proper installation depth of the fluid conduit 12 that each conduit receiver 22 is sized for. The first conduit receiver 54 has a first height 66 defined between proximal end 46 and distal end 40. The second conduit receiver 56 has a second height 68, less than the first height 66, defined between proximal end 48 and distal end 42. The third conduit receiver 58 has a third height 70, less than the first and second heights 66, 68, defined between proximal end 50 and distal end 44.

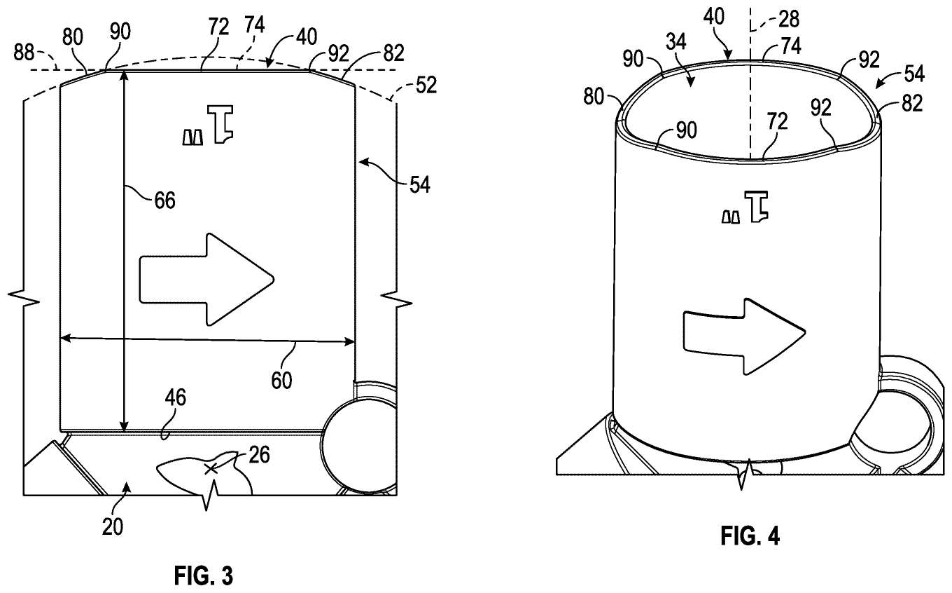

Referring to FIGS. 3-8, the distal ends 40, 42, 44 of each conduit receiver 22 are shaped to both: (i) allow the preparation tool 10 to fit and rotate within the predetermined diameter 52 while maintaining diameters 60, 62, 64, and (ii) provide the proper installation depth with heights 66, 68, 70. The distal end 40, 42 of the first and second conduit receivers 54, 56 include a pair of planar segments 72, 74, 76, 78 and a pair of recessed segments 80, 82, 84, 86 as shown in FIGS. 3-6. Each pair of planar segments 72, 74, 76, 78 is arranged to lie along a common plane 88, 89 that is perpendicular to each corresponding receiver axis 28, 30 passing therethrough. Each pair of recessed segments 80, 82, 84, 86 extends outwardly away from the central axis 26. Recessed segments 80, 82 are coupled to opposing ends of planar segments 72, 74. Recessed segments 86, 88 are coupled to opposing ends of planar segments 76, 78. Each pair of recessed segments 80, 82, 84, 86 provide the first and second conduit receivers 54, 56 with chamfered edges along their circumferential ends relative to the central axis 26 so that the entire preparation tool 10 fits within and is rotatable within the predetermined diameter 52. Each pair of planar segments 72, 74, 76, 78 cooperates with each respective proximal end 46, 48 to define the first and second heights 66, 68 of the first and second conduit receivers 54, 56 for proper depth marking. In some embodiments, the planar segments 72, 74, 76, 78 and the recessed segments 80, 82, 84, 86 can be referred to as separate distal ends of the corresponding conduit receiver 22.

In the illustrative embodiment, the recessed segments 80, 82, 84, 86 are arcuate and have a curvature that substantially matches a curvature of the predetermined diameter 52. In this way, each recessed segment 80, 82, 84, 86 may have a radius with a center that is located at the central axis 26. In other embodiments, the recessed segments 80, 82, 84, 86 have a different curvature such that their center lies radially between an outer boundary of the predetermined diameter 52 and the central axis 26. In yet another embodiment, the recessed segments 80, 82, 84, 86 may not be arcuate and may extend along a planc such that the recessed segments 80, 82, 84, 86 are arranged at an angle relative to their respective planar segments 72, 74, 76, 78 at all portions of the recessed segments 80, 82, 84, 86. In each of these instances, the recessed segments 80, 82, 84, 86 fit within the predetermined diameter 52 so that the preparation tool 10 is able to rotate about the central axis 26 without interference from drywall panels 18. All of the planar segments 72, 74, 76, 78 are spaced apart inwardly from the outer boundary of the predetermined diameter 52. In some embodiments, distal ends # of each conduit receiver 22 may include a transition point 90, 92, 94, 96 where each planar segment joins one of the recessed segments 72, 74, 76, 78. The transition points 90, 92, 94, 96 may be located at or inward from the outer boundary of the predetermined diameter 52.

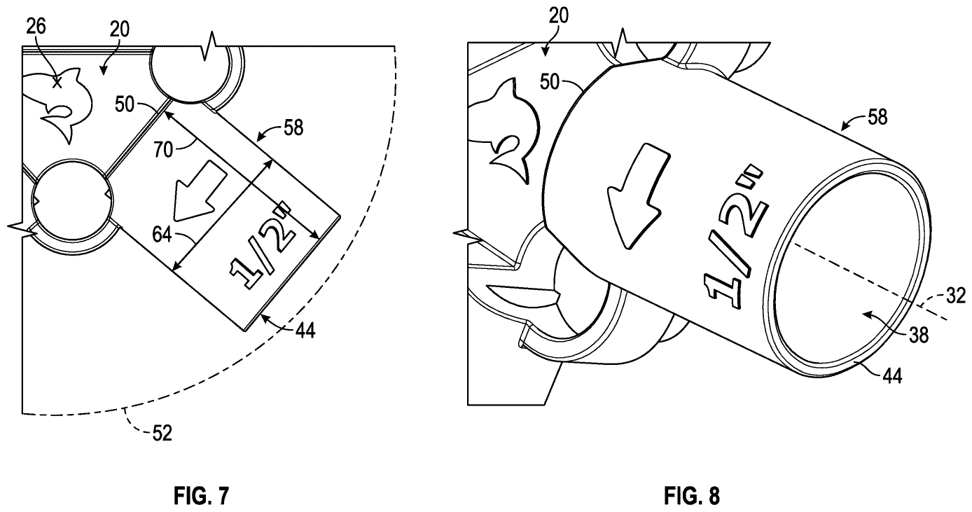

The third conduit receiver 58 is sufficiently small such that it does not extend all the way to the outer boundary of the predetermined diameter 52 as shown in FIGS. 7 and 8. Thus, the entire distal end 44 of the third conduit receiver 58 is planar and is perpendicular to its respective receiver axis 32. The entire distal end 44 of the third conduit receiver 58 is also spaced apart from the outer boundary of the predetermined diameter 52.

Referring again to FIGS. 1 and 2, the hub 20 is formed to include a pair of recesses or pockets 98, 100. Each pocket 98, 100 is configured to house one of the deburr elements 24 to position the deburr elements relative to the plurality of conduit receivers 22. Each conduit receiver 22 is formed to include a cutout 102, 104, 106 that allows a portion of one of the deburr elements 24 to extend into the interior 28, 30, 32 of each respective conduit receiver 22 to engage a fluid conduit 12 therein.

Another aspect of the present disclosure relates to a method of forming the preparation tool 10. The method includes forming the unitary body 25 of the preparation tool 10. The unitary body 25 is formed with the hub 20 and the plurality of conduit receivers 22. The method includes forming at least some of the conduit receivers 22 with recessed segments 80, 82, 84, 86 such that the preparation tool 10 has a total profile or footprint that allows the preparation tool 10 to be rotated about the central axis 26 within the predetermined diameter 52. The method may further include inserting the deburr elements 24 into pockets 98, 100 formed into the unitary body 25.

A further aspect of the present disclosure relates to a method for using the preparation tool 10. The method includes inserting the preparation tool between two drywall panels 18. The method may further include rotating the preparation tool 10 about the central axis 26 within the predetermined diameter 52 and aligning one of the conduit receivers 22 with an end of a fluid conduit 12. The method may further include inserting the end of the fluid conduit 12 into the open interior of the conduit receiver 22 and contacting the end of the fluid conduit 12 with one of the deburr elements 24. The method may further include rotating the preparation tool 10 about the corresponding receiver axis 28, 30, 32 to deburr the end of the fluid conduit 12. The method may further include marking the conduit with a proper installation depth using a distal end of the conduit receiver 22. The method may further include inserting the end of the fluid conduit 12 into the coupling 14 to the mark indicated on the fluid conduit.

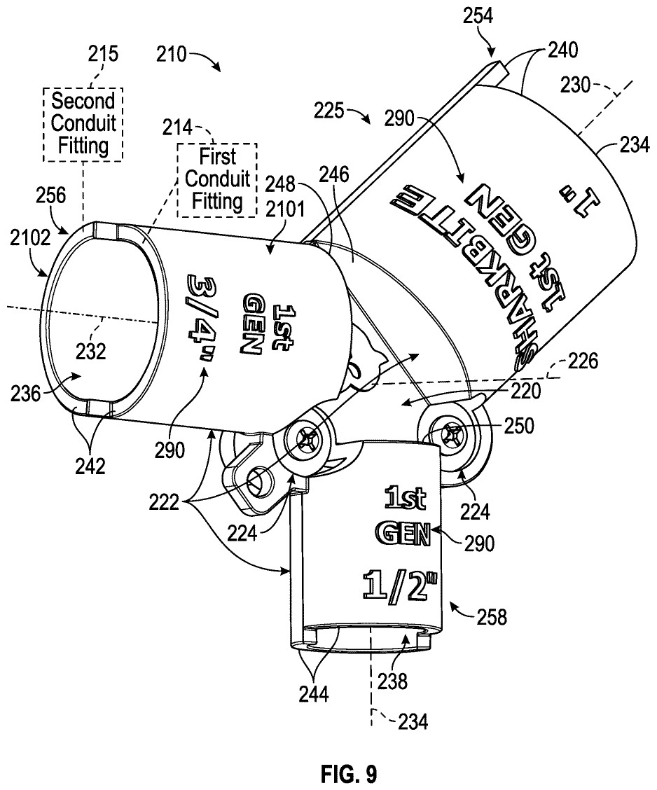

Another embodiment of a conduit or pipe preparation tool 210, in accordance with the present disclosure, is shown in FIGS. 9-14. The preparation tool 210 is configured to be used by an installer to prepare an end of the fluid conduit 12, such as a copper pipe, PEX tubing, CPVC pipe, PVC tubing, and the like, for attachment to one or more conduit connectors (or fittings) 14, such as a push-to-connect, push-fit, or other plumbing connector or coupling. As an example, the preparation tool 210 is configured to deburr or otherwise remove debris from an end of the fluid conduit 12 for preparation of the fluid conduit 12 for insertion into the connector 14, e.g., to reduce the likelihood of damage to components of the plumbing coupling, such as an O-ring seal, and further to help ensure that the fluid conduit 12 subsequently forms a substantially watertight connection with the connector 14. The preparation tool 210 can also be used for depth measurement so that the installer can mark an insertion depth on the fluid conduit 12 that corresponds with a proper installation depth of the fluid conduit 12 with the connector 14.

As an example, the preparation tool 210 can be used to deburr and depth mark a fluid conduit for a SharkBite® Branded Push-to-Connect Plumbing System manufactured by Reliance Worldwide Corporation located at 2300 Defoor Hills Rd NW, Atlanta, GA 30318. An example of a push to connect connector or coupling is provided in U.S. Pat. No. 11,525,534, issued Dec. 13, 2022, which is incorporated by reference herein in its entirety.

Referring to FIGS. 9-11, the preparation tool 210 includes a hub 220, a plurality of conduit receivers 222 coupled to the hub 220, and a plurality of conduit deburr portions or elements 224 coupled to the plurality of conduit receivers 222. The deburr elements 224 include deburring knives or other suitable cutting portions, such as circular cutting portions as shown throughout the figures of the present application. The plurality of conduit receivers 222 are coupled with the hub 220 to form a tool body 225. The tool body 225 can be formed as part of a single injection molding process or in multiple pieces by separate molding processes and then subsequently assembled. In one example, the tool body 225 is formed from a polymeric material, such PP, PE, PA, or other polymeric materials. The tool body 225 can be formed from other suitable materials, e.g., composite or synthetic materials, without departing from the scope of the present disclosure.

The plurality of conduit receivers 222 and deburr elements 224 are arranged radially around a central axis 226 that extends through the hub 220 as shown in FIGS. 9-14. Each of the plurality of conduit receivers 222 has a cylindrical shape that extends circumferentially about a respective axis 228, 230, 232 to provide an open interior 234, 236, 238 for each of the conduit receivers 222. Each deburr element 224 is coupled to a proximal end 246, 248, 250 of at least one of the conduit receivers 222. Each deburr element 224 extends partially into at least one of the open interiors 234, 236, 238 to engage and remove material from an end of the fluid conduit 12 when the conduit 12 is inserted therein and the tool 210 is rotated about the corresponding respective axis 228, 230, 232.

Each open interior 234, 236, 238 is sized to receive a corresponding fluid conduit 12 of a specific diameter along a corresponding receiver axis 228, 230, 232 to help to guide the corresponding fluid conduit 12 to one of the plurality of deburr elements 224. Once the fluid conduit 12 is fully inserted, e.g., inserted to a depth where the end of the conduit engages or contacts a corresponding deburr element, into the corresponding conduit receiver 222, the preparation tool 210 is configured to be rotated about the corresponding axis 228, 230, 232 so that at least one of the deburr elements 224 engages and removes burrs, debris, or other undesired material from the end of the fluid conduit 12. At the same time, the fluid conduit 12 can also be marked at the proper installation depth by placing a mark (not shown) on a side of the fluid conduit 12 that aligns with a distal end 240, 242, 244 of the corresponding conduit receiver 222. This marking helps to ensure the conduit 12 is sufficiently inserted, e.g., fully inserted, into a corresponding connector or coupling 14, e.g., such that when the end of the conduit 12 engages an end stop, the conduit 12 sufficiently engages a sealing o-ring of the coupling when the marking reaches an end of the coupling 14. Each receiver axis 228, 230, 232 may intersect the central axis 226 and can be arranged perpendicular to the central axis 226. In this way, each of the conduit receivers 222 extends outwardly away from the central axis 226, the hub 20, and from one another. In some embodiments, one or more of the receiver axes 228, 230, 232 may not extend through the central axis 226 and may not be perpendicular to the central axis 226.

Like preparation tool 10, the preparation tool 210 is sized, structured, and configured to fit in hard-to-access areas so that the installer can easily access the ends of fluid conduits 12 between studs 16 and/or wall panels 18 of a wall in a building, for example. In an exemplary building, walls of the building are constructed with studs 16 and drywall panels 18 coupled to each end of the studs 16. Typical studs 16 are referred to as having a 2 inch thickness and a 4 inch width (i.e. a 2 by 4 wood plank), but can have an actual thickness of about 1.5 inches and an actual width of about 3.5 inches. In the illustrative embodiment, the distal end 240, 242, 244 of each of the plurality of conduit receivers 222 is spaced apart from the central axis 26 by a distance of less than or equal to 3.5 inches so that the preparation tool 210 is free to rotate about the central axis 226 at or within the predetermined diameter 52 of less than or equal to 3.5 inches. The predetermined diameter 52 represents the actual width of a typical stud 16 and the spacing between two drywall panels 18, which is defined substantially by the actual width of the stud 16. In the illustrative embodiment, the preparation tool 210 also has an aspect ratio of about 1:1 in its widest and tallest dimensions. In this way, the preparation tool 210 is able to reside completely within the predetermined diameter 52. Because of these dimensional attributes of the preparation tool 210, an installer is able to reach between two drywall panels 18 with the central axis 226 of the preparation tool 210 arranged perpendicularly to the stud 16. With the preparation tool 10 between the two drywall panels 18, the installer is free to rotate the preparation tool 210 about the central axis 226 without interference with the drywall panels 18 to align any of the conduit receivers 222 with an end of the fluid conduit 12 also between the two drywall panels 18 at any orientation relative to the stud 16 and the walls 18. The preparation tool 210 can also be rotated about any of the receiver axes 228, 230, 232 within the predetermined diameter 52 to deburr the end of the fluid conduit 12 between two drywall panels 18.

In the illustrative embodiment, the plurality of conduit receivers 222 includes a first conduit receiver 254, a second conduit receiver 256, and a third conduit receiver 258 each located at different circumferential locations relative to one another about the central axis 226 as shown in FIG. 9. The conduit receivers 254, 256, 258 each have a different diameter from one another to receive different conduits that have a corresponding diameter. For example, the first conduit receiver 254 has a first diameter 260 that is sized to fit a 1 inch diameter conduit. The second conduit receiver 256 has a second diameter 262, smaller than the first diameter 260, which is sized to fit a ¾ inch diameter conduit. The third conduit receiver 258 has a third diameter 264, smaller than the first and second diameters 260, 262, which is sized to fit a ½ inch conduit. It should be noted that, the conduit receivers 222 may have any suitable diameter to fit conduits of any size so long as the preparation tool 210 is still able to fit and rotate within the predetermined diameter 52. For example, any of the conduit receivers 222 may have a diameter for receipt of larger or smaller diameter conduits, e.g., a 6 inch diameter conduit, a 5 inch diameter conduit, a 4 inch diameter conduit, a 3 inch diameter conduit, a 2½ inch diameter conduit, a 2 inch diameter conduit, a 1½ inch diameter conduit, a 1¼ inch diameter conduit, a ⅜ inch diameter conduit, a ¼ inch diameter conduit, a ⅛ inch diameter conduit, etc.

Like preparation tool 10, the conduit receivers 222 of preparation tool 210 are sized with different heights from one another so that the installation depth mark location provided by each conduit receiver 222 corresponds with the proper installation depth of the fluid conduit 12 that each conduit receiver 222 is sized for. However, each conduit receiver 222 is also sized to provide a corresponding installation depth mark location for different pipe fittings 14, which can require a different insertion depth between one another. Accordingly, each distal end 240, 242, 244 of the conduit receivers 222 has at least a first segment 270, 272, 274 configured to provide a first installation depth mark location for a first pipe fitting 214 and a second segment 280, 282, 284 configured to provide a second installation depth mark location for a second pipe fitting 215. The first and second installation depth mark locations are different from one another because the different pipe fittings 214, 215 require different insertion depths in order to form a proper connection with the conduit 12.

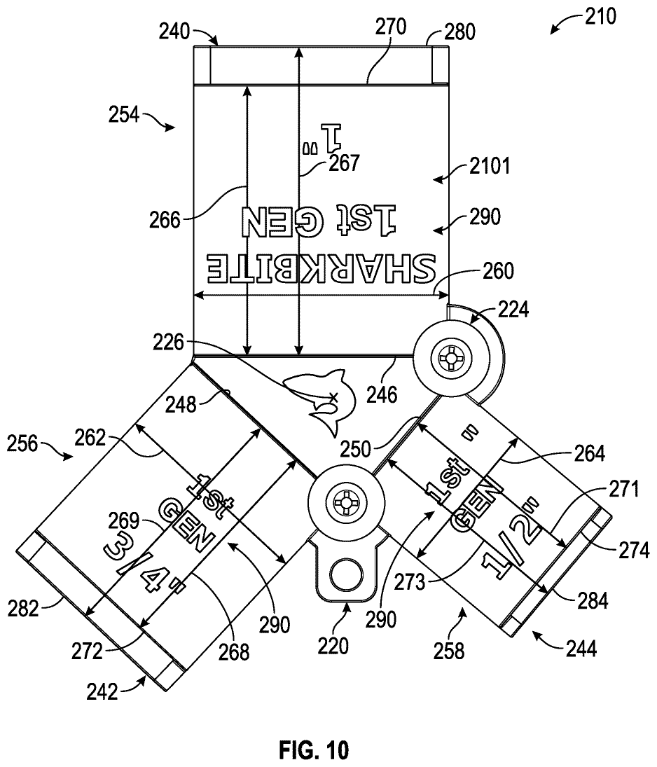

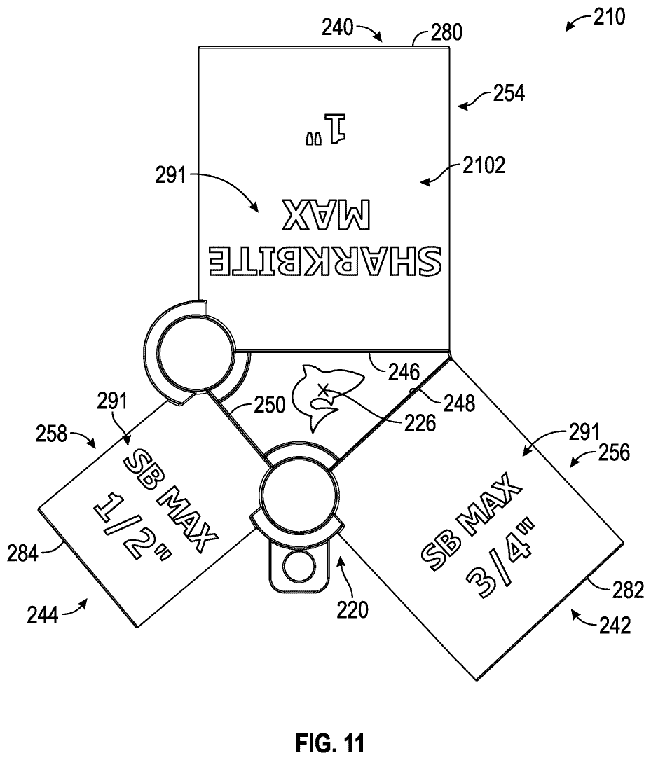

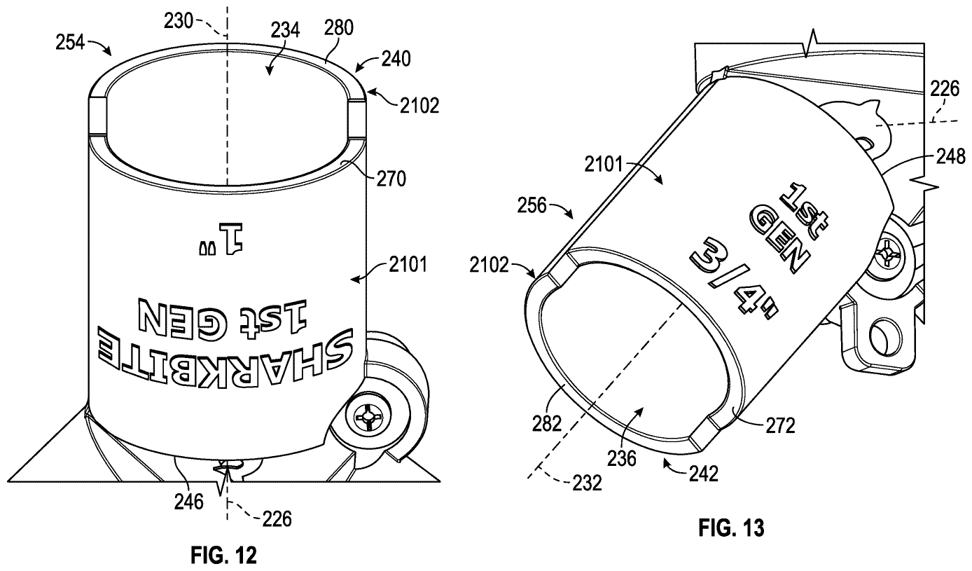

Illustratively, the distal end 240 of the first conduit receiver 254 has first and second segments, or distal ends, 270, 280 (see FIG. 12) that provide first and second heights 266, 267 (see FIG. 10) from the proximal end 246, respectively. Each height 266, 267 can be used to mark the same conduit 12 for use with either pipe fitting 214, 215, or both. In the illustrative embodiment, each segment 270, 280 extends only halfway about axis 230. However, in some embodiments, one or both of the segments 270, 280 may extend a larger or smaller distance about axis 230. For example, each segment 270, 280 may extend only 90 degrees about axis 230 if the distal end 240 of conduit receiver 254 has four segments, which may each have a different height from proximal end 246.

Illustratively, the distal end 242 of the second conduit receiver 256 has first and segments, or distal ends, 272, 282 (see FIG. 13) that provide first and second heights 268, 269 (see FIG. 10) from proximal end 248, respectively. Each height 268, 269 can be used to mark the same conduit 12 for use with either pipe fitting 214, 215, or both. In the illustrative embodiment, each segment 272, 282 extends only halfway about axis 232. However, in some embodiments, one or both of the segments 272, 282 may extend a larger or smaller distance about axis 232. For example, each segment 272, 282 may extend only 90 degrees about axis 232 if the distal end 242 of conduit receiver 256 has four segments, which may each have a different height from proximal end 248.

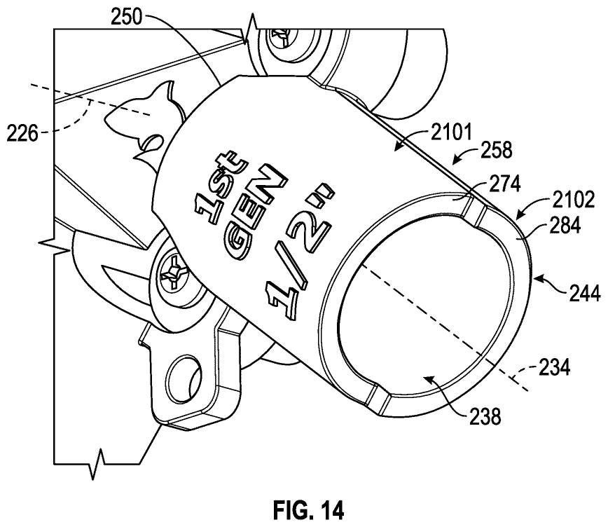

Illustratively, the distal end 244 of the third conduit receiver 258 has first and second segments, or distal ends, 274, 284 (see FIG. 14) that provide first and second heights 271, 273 (see FIG. 10) from the proximal end 250, respectively. Each height 266, 267 can be used to mark the same conduit 12 for use with either pipe fitting 214, 215, or both. In the illustrative embodiment, each segment 274, 284 extends only halfway about axis 234. However, in some embodiments, one or both of the segments 274, 284 may extend a larger or smaller distance about axis 234. For example, each segment 274, 284 may extend only 90 degrees about axis 234 if the distal end 244 of conduit receiver 256 has four segments, which may each have a different height from proximal end 250.

In the illustrative embodiment, the preparation tool 210 is formed as two separate halves 2101, 2102 such that each of the conduit receivers 254, 256, 258 also have two halves. Accordingly, the first segment 270, 272, 274 of each conduit receiver 254, 256, 258 is formed integrally with the first half 2101 and the second segment 280, 282, 284 of cach conduit receiver 254, 256, 258 is formed integrally with the second half 2102. The two halves 2101, 2102 can be joined together after being formed by any suitable method including welding, adhering, heat sealing, etc. Each half 2101, 2102 can be marked with indicia 290, 291 to indicate to users which fitting 214, 215 the installation mark locations correspond to. The indicia 290, 291 can include one or more of text, icons, symbols, numbers, colors, etc.

In this specification, adjectives such as left and right, top and bottom, first and second, and the like may be used to distinguish one element or action from another element or action without necessarily requiring or implying any actual such relationship or order. In addition or alternatively, references herein to the positions of elements (e.g., top, bottom, above, below) may merely be used to describe the orientation of various elements in the Figures. It should be noted that the orientation of various elements may differ according to various exemplary embodiments, and that such variations are intended to be encompassed by the present disclosure. Where context permits, reference to a component, an integer, or a step (or the alike) is not to be construed as being limited to only one of that component, integer, or step, but rather could be one or more of that component, integer, or step.

As used herein, the relative directions and terms “inward” and “outward” are referenced with respect to a longitudinal axis, with inward being in a direction radially toward the longitudinal axis and outward being in a direction radially away from the longitudinal axis.

The relative directions and terms “distal” and “proximal” are used with respect to a central axis, with the distal direction being away from the central axis, and the proximal direction being toward the central axis. The relative direction and term lateral or laterally are in a plane generally orthogonal to the longitudinal axis.

As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof arc modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

Various exemplary descriptions above contain instances of representative ranges, dimensions and/or tolerances for certain components. These are provided by way of illustration and not by way of limitation. Unless otherwise indicated, all numbers expressing quantities of properties, parameters, conditions, and so forth, used in the specification and claims are to be understood as being modified in all instances by the terms “about” or “approximately.” Accordingly, unless indicated to the contrary, the numerical parameters set forth in the following specification and attached claims are approximations. Any numerical parameter should at least be construed in light of the number reported significant digits and by applying ordinary rounding techniques. The terms “about” or “approximately” when used before a numerical designation, e.g., a dimension of a measured property, indicates approximations which may vary by (+) or (−) 10%, 5% or 1%.

Although the figures and description may illustrate a specific order of method steps, the order of such steps may differ from what is depicted and described, unless specified differently above. Also, two or more steps may be performed concurrently or with partial concurrence, unless specified differently above.

In at least one aspect, a conduit preparation tool includes a hub. The preparation tool may further includes a plurality of conduit receivers coupled to the hub and spaced apart from one another around a central axis extending through the hub. Each of the plurality of conduit receivers may have a cylindrical shape with a different diameter from one another to receive a respective conduit therein. Each of the plurality of conduit receivers may have a respective receiver axis extending through the central axis. The preparation tool may further include a plurality of deburr elements coupled to the hub and arranged to extend partially into at least one of the conduit receivers to trim portions of the respective conduit received therein in response to rotation of the preparation tool about the respective receiver axis.

In at least one aspect, each of the plurality of conduit receivers is spaced apart from the central axis by a distance of less than or equal to 3.5 inches so that the preparation tool is free to rotate about the central axis within a circular plane having a diameter of 3.5 inches.

In at least one aspect, the plurality of conduit receivers includes a first conduit receiver, a second conduit receiver, and a third conduit receiver. In at least one aspect, the first conduit receiver and the second conduit receiver each include a distal end having a pair of planar segments and a pair of inclined segments. In at least one aspect, the third conduit receiver has a distal end that is entirely planar.

In at least one aspect, the first conduit receiver has a first diameter equal to about 1 inch, the second conduit receiver has a second diameter equal to about ¾ inch, and the third conduit receiver has a third diameter equal to about ½ inch.

In at least one aspect, each of the inclined segments are arcuate segments and have a radius of curvature with a center at the central axis.

In at least one aspect, each of the conduit receivers further includes a proximal end coupled to the hub, and each of the planar segments is spaced apart from each corresponding proximal end by a predetermined distance to provide an insertion depth of the respective conduit received therein that corresponds with a proper installation depth of the respective conduit with a corresponding conduit connector or coupling.

In at least one aspect, at least one conduit receiver included in the plurality of conduit receivers includes: (i) a first distal end spaced a first height from a proximal end of the at least one conduit receiver at the hub, and (ii) a second distal end spaced a second height from the proximal end, and wherein the second height is less than the first height.

In at least one aspect, the at least one conduit receiver has a first segment at the first distal end and a second segment at the second distal end and spaced circumferentially from the first segment about the respective receiver axis of the at least one conduit receiver. The first height is defined between the proximal end and the first segment and the second height is defined between the proximal end and the second segment.

In at least one aspect, both the first segment and the second segment extend circumferentially halfway around the respective receiver axis.

In at least one aspect, a plane extending through each of the plurality of conduit receivers and perpendicular to the central axis divides the first segment from the second segment.

In at least one aspect, the first segment is configured to provide a first depth marker for a first conduit fitting and the second segment is configured to provide a second depth marker for a second conduit fitting different than the first conduit fitting.

In at least one aspect, the second segment is a recessed segment relative to the first segment.

In another aspect of the present disclosure, a plumbing system includes a conduit. The plumbing system may further include a first conduit fitting configured to receive a first insertion depth of the conduit. The plumbing system may further include a second conduit fitting configured to receive a second insertion depth of the conduit, the second insertion depth being less than the first insertion depth. The plumbing system may further include a conduit preparation tool. The preparation tool includes a hub; a plurality of conduit receivers coupled to the hub and spaced apart from one another around a central axis extending through the hub, each of the plurality of conduit receivers having a cylindrical shape with a different diameter from one another to receive a respective pipe therein, each of the plurality of conduit receivers having a respective receiver axis extending through the central axis; and a plurality of deburr elements coupled to the hub and arranged to extend partially into at least one of the conduit receivers to trim portions of the respective pipe received therein in response to rotation of the pipe preparation tool about the respective receiver axis.

In at least one aspect, at least one conduit receiver included in the plurality of conduit receivers includes: (i) a first distal end spaced a first height from a proximal end of the at least one conduit receiver at the hub, and (ii) a second distal end spaced a second height from the proximal end, and wherein the first height corresponds to the first insertion depth and the second height corresponds to the second insertion depth.

In at least one aspect, the at least one conduit receiver has a first segment at the first distal end and a second segment at the second distal end and spaced circumferentially from the first segment about the respective receiver axis of the at least one conduit receiver, and the first height is defined between the proximal end and the first segment and the second height is defined between the proximal end and the second segment.

In at least one aspect, both the first segment and the second segment extend circumferentially halfway around the respective receiver axis.

In at least one aspect, a plane extending through each of the plurality of conduit receivers and perpendicular to the central axis divides the first segment from the second segment.

In at least one aspect, each of the plurality of conduit receivers is spaced apart from the central axis by a distance of less than or equal to 3.5 inches so that the preparation tool is free to rotate about the central axis within a predetermined diameter of about 3.5 inches.

In at least one aspect, the plurality of conduit receivers includes a first conduit receiver, a second conduit receiver, and a third conduit receiver, and the first conduit receiver and the second conduit receiver each include a distal end having a pair of planar segments and a pair of recessed segments.

In at least one aspect, the third conduit receiver has a distal end that is entirely planar.

In at least one aspect, each of the recessed segments are arcuate segments and have a radius of curvature with a center at the central axis.

What is claimed is

1. A conduit preparation tool comprising:
a hub;
a plurality of conduit receivers coupled to the hub and spaced apart from one another around a central axis extending through the hub, each of the plurality of conduit receivers having a cylindrical shape with a different diameter from one another to receive a respective pipe therein, each of the plurality of conduit receivers having a respective receiver axis extending through the central axis; and
a plurality of deburr elements coupled to the hub and arranged to extend partially into at least one of the conduit receivers to trim portions of the respective pipe received therein in response to rotation of the pipe preparation tool about the respective receiver axis;
wherein each of the plurality of conduit receivers is spaced apart from the central axis by a distance of less than or equal to 3.5 inches so that the preparation tool is free to rotate about the central axis within a predetermined diameter of about 3.5 inches.

2. The pipe preparation tool of claim 1, wherein:
the plurality of conduit receivers includes a first conduit receiver, a second conduit receiver, and a third conduit receiver, and
the first conduit receiver and the second conduit receiver each include a distal end having a pair of planar segments and a pair of recessed segments.

3. The pipe preparation tool of claim 2, wherein the third conduit receiver has a distal end that is entirely planar.

4. The pipe preparation tool of claim 2, wherein:
the first conduit receiver has a first diameter that is configured to receive a conduit with a diameter equal to about 1 inch,
the second conduit receiver has a second diameter that is configured to receive a conduit with a diameter equal to about ¾ inch, and
the third conduit receiver has a third diameter that is configured to receive a conduit with a diameter equal to about ½ inch.

5. The pipe preparation tool of claim 2, wherein each of the recessed segments are arcuate segments and have a radius of curvature with a center at the central axis.

6. The pipe preparation tool of claim 5, wherein each of the conduit receivers further includes a proximal end coupled to the hub, and each of the planar segments is spaced apart from each corresponding proximal end by a predetermined distance to provide a pipe insertion depth of the respective pipe received therein that corresponds with a proper installation depth of the respective pipe with a corresponding pipe connector.

7. A conduit preparation tool comprising:
a hub;
a plurality of conduit receivers coupled to the hub and spaced apart from one another around a central axis extending through the hub, each of the plurality of conduit receivers having a cylindrical shape with a different diameter from one another to receive a respective pipe therein, each of the plurality of conduit receivers having a respective receiver axis extending through the central axis; and
a plurality of deburr elements coupled to the hub and arranged to extend partially into at least one of the conduit receivers to trim portions of the respective pipe received therein in response to rotation of the pipe preparation tool about the respective receiver axis;
wherein at least one conduit receiver included in the plurality of conduit receivers includes: (i) a first distal end spaced a first height from a proximal end of the at least one conduit receiver at the hub, and (ii) a second distal end spaced a second height from the proximal end, and wherein the second height is less than the first height.

8. The conduit preparation tool of claim 7, wherein the at least one conduit receiver has a first segment at the first distal end and a second segment at the second distal end and spaced circumferentially from the first segment about the respective receiver axis of the at least one conduit receiver, and the first height is defined between the proximal end and the first segment and the second height is defined between the proximal end and the second segment.

9. The conduit preparation tool of claim 8, wherein both the first segment and the second segment extend circumferentially halfway around the respective receiver axis.

10. The conduit preparation tool of claim 9, wherein a plane extending through each of the plurality of conduit receivers and perpendicular to the central axis divides the first segment from the second segment.

11. The conduit preparation tool of claim 8, wherein the first segment is configured to provide a first depth marker for a first conduit fitting and the second segment is configured to provide a second depth marker for a second conduit fitting different than the first conduit fitting.

12. The conduit preparation tool of claim 8, wherein the second segment is a recessed segment relative to the first segment.

13. A plumbing system comprising
a conduit;
a first conduit fitting configured to receive a first insertion depth of the conduit;
a second conduit fitting configured to receive a second insertion depth of the conduit, the second insertion depth being less than the first insertion depth; and
a conduit preparation tool comprising:
a hub;
a plurality of conduit receivers coupled to the hub and spaced apart from one another around a central axis extending through the hub, each of the plurality of conduit receivers having a cylindrical shape with a different diameter from one another to receive a respective pipe therein, each of the plurality of conduit receivers having a respective receiver axis extending through the central axis; and
a plurality of deburr elements coupled to the hub and arranged to extend partially into at least one of the conduit receivers to trim portions of the respective pipe received therein in response to rotation of the pipe preparation tool about the respective receiver axis,
wherein at least one conduit receiver included in the plurality of conduit receivers includes: (i) a first distal end spaced a first height from a proximal end of the at least one conduit receiver at the hub, and (ii) a second distal end spaced a second height from the proximal end, and wherein the first height corresponds to the first insertion depth and the second height corresponds to the second insertion depth.

14. The plumbing system of claim 13, wherein the at least one conduit receiver has a first segment at the first distal end and a second segment at the second distal end and spaced circumferentially from the first segment about the respective receiver axis of the at least one conduit receiver, and the first height is defined between the proximal end and the first segment and the second height is defined between the proximal end and the second segment.

15. The plumbing system of claim 14, wherein both the first segment and the second segment extend circumferentially halfway around the respective receiver axis.

16. The plumbing system of claim 15, wherein a plane extending through each of the plurality of conduit receivers and perpendicular to the central axis divides the first segment from the second segment.

17. The plumbing system of claim 13, wherein each of the plurality of conduit receivers is spaced apart from the central axis by a distance of less than or equal to 3.5 inches so that the preparation tool is free to rotate about the central axis within a predetermined diameter of about 3.5 inches.

18. The plumbing system of claim 13, wherein:
the plurality of conduit receivers includes a first conduit receiver, a second conduit receiver, and a third conduit receiver, and
the first conduit receiver and the second conduit receiver each include a distal end having a pair of planar segments and a pair of recessed segments.

19. The pipe preparation tool of claim 18, wherein the third conduit receiver has a distal end that is entirely planar.

20. The pipe preparation tool of claim 18, wherein each of the recessed segments are arcuate segments and have a radius of curvature with a center at the central axis.
